(19) United States
(12) Patent Application Publication
(10) Pub. No.: US 2012/0143360 A1
(43) Pub. Date: Jun. 7, 2012

(54) SYNCHRONOUS FADER PROCESSING IN AUDIO SYSTEMS

(76) Inventors: Jõrn Henneberg, Monrovia, CA (US); Charles D. Boehm, Glendora, CA (US); Christopher R. Epstein, Clearwater, FL (US); Jerry T. Thatcher, Clearwater, FL (US)

(21) Appl. No.: 12/959,710

(22) Filed: Dec. 3, 2010

(51) Int. Cl. G06F 17/00

(52) U.S. Cl. 700/94

(57) ABSTRACT

An audio processing system includes user-operable analog controls for real time control of audio, whose outputs are digitized synchronously with the audio to be controlled. Audio and control information sampling rates are 44.1 kHz or higher, resolution of the audio samples is 24-bit, and that of the control samples between 8-bit and 24-bit. Synchronous digitization of analog controller output may be used to control an arbitrary combination of digital and analog audio inputs. The described systems and methods eliminate lag and unresponsiveness experienced by audio control operators using conventional systems, particularly when using a cross-fader in DJ performance systems. The increased sample resolution preserves nuances of performer actions, and eliminates certain quantization artifacts.

### BACKGROUND

In controller devices for digital audio computer systems, the volumes of the various audio channels are controlled by analog controls referred to as faders, usually implemented as sliders or knobs. In disc jockey (DJ) systems, the mixing levels of two incoming audio sources are controlled simultaneously using a single control referred to as a cross-fader. The analog positions of the faders are digitized using inexpensive A/D converters, which generate samples at an effective rate of 0.1 to 1 kHz per control. In such audio systems, the audio signals being controlled by the faders are sampled using A/D converters that operate in the range of 44.1 kHz or higher. In most cases, the digitized audio signals are buffered by the receiving computer system, which results in latency. The techniques and methods described herein address problems that can be caused by the volume control sampling rate and audio signal latencies.

### SUMMARY

An audio processing system digitizes analog audio controls synchronously with the audio being controlled. Synchronous processing eliminates latency between user-operated analog audio controls and the audio information being controlled. Higher resolution sampling of the audio control signals preserves fine-scale user adjustments and eliminates distracting quantization artifacts.

In general, in one aspect, a digital audio system comprises: an audio control device including one or more user-operable analog controls for real time control of a plurality of channels of audio information, wherein each of the one or more user-operable analog controls outputs an analog control signal corresponding to a position of that analog control, and wherein the audio information is digitized at an audio sampling rate; an analog to digital converter; and a host computer, wherein the analog to digital converter receives the one or more analog control signals, samples the analog control signals at the audio sampling rate, and outputs control samples that are synchronous with the audio information, and wherein the host computer receives the control samples and the plurality of channels of audio information, and synchronously processes the audio information in accordance with the control samples.

Various embodiments include one or more of the following features. The analog to digital converter samples the analog control signals at a resolution of 24 bits or higher. The analog to digital converter samples the analog control signals at a resolution greater than or equal to 8 bits and less than or equal to 16 bits. The audio information is digitized by the analog to digital converter. The system includes a second analog to digital converter, and the audio information is digitized by the second analog to digital converter. The audio information is received by the digital audio system in digital form from a digital storage device. The digital audio system is a DJ performance system. The one or more user operable analog controls includes a cross-fader. The audio sampling rate is greater than or equal to 44.1 kHz.

In general, under another aspect, an audio processing method comprises: receiving at an analog to digital converter one or more analog control signals indicative of a position of a corresponding one or more user-operable analog controls for real time control of a plurality of channels of audio information, wherein the audio information is digitized at an audio sampling rate; using the analog to digital converter, sampling the one or more analog control signals at the audio sampling rate and outputting the sampled control signals synchronously with samples of the audio information; receiving at the host computer the sampled control signals and the plurality of channels of audio information; and synchronously processing the plurality of channels of audio information by the host computer in accordance with the control samples.

Various embodiments of the audio processing method include one or more of the devices and features described above in connection with the digital audio system.

In general, under a further aspect, a digital audio system comprises: an audio control device including one or more user-operable analog controls for real time control of a plurality of channels of audio information, wherein each of the one or more user-operable analog controls outputs an analog control signal corresponding to a position of that analog control, and wherein the audio information is digitized at an audio sampling rate; an analog to digital converter; and a digital signal processor; wherein the analog to digital converter receives the one or more analog control signals, samples the analog control signals at the audio sampling rate, and outputs control samples that are synchronous with the audio information, and wherein the digital signal processor receives the control samples and the plurality of channels of audio information, and synchronously processes the audio information in accordance with the control samples.

### BRIEF DESCRIPTION OF THE DRAWINGS

FIG. 1 is high level block diagram of a prior art audio control system.

FIG. 2 is a high level block diagram of a hosted audio control system with synchronous fader processing.

FIG. 3 is a high level block diagram of a standalone audio control system with synchronous fader processing.

### DETAILED DESCRIPTION

In the audio controller devices that are prevalent, the great disparity between the audio sampling rate and the fader control sampling rate can result in several problems. First, the digital information created for the analog controls is much coarser than the digital audio information to which the processing is applied as a result of the much lower sampling rate of the A/D converter. The fader control is sampled at about 1 kHz, but the audio is sampled at a rate of 44.1 kHz or higher. As a result, the computer is not always able to capture the actual timing of the fader movements performed by the user in relation to the audio, and a lag may be noticeable. Second, the A/D converter for the control information generally has lower bit-depth resolution, with only 128 (7-bit) digital positions available to represent the fader position information, compared to the 16-bit, 24-bit, or higher resolutions for the audio. The resulting control information is usually transmitted as a 7-bit MIDI signal. This can mean that fine nuances of the user's fader movements cannot always be captured by the system. Another consequence of the coarse digital control information can be a digital “zipper noise” created when the movement of an analog fader generates differences of adjacent control samples greater than a certain threshold value, and this control information is applied directly to the audio. This can occur for rapid movements of the fader, such as when a fader is slid from one end of its range to the other in a single rapid movement. Current audio controllers attempt to address this problem by interpolating between adjacent samples of controller information, thus artificially up-sampling the information to match the audio sample rate. A third problem is the latency that is introduced in the audio signal when the audio host connection needs to buffer the audio. Since the control information is not buffered, the audio may lag behind the control information, and this may contribute to a lag between fader movements and their effect on the audio. In addition, the control A/D conversion rate neither matches, nor is synchronous with the audio conversion rate, and may be subject to jitter as a result of fluctuating processing loads on the microcontroller, which in most cases also has to handle the user interface including displaying meters, sequencing of LEDs, button scanning, and so on. This issue can be addressed by using a time-stamping scheme, enabling the system to align the audio and the control information with each other.

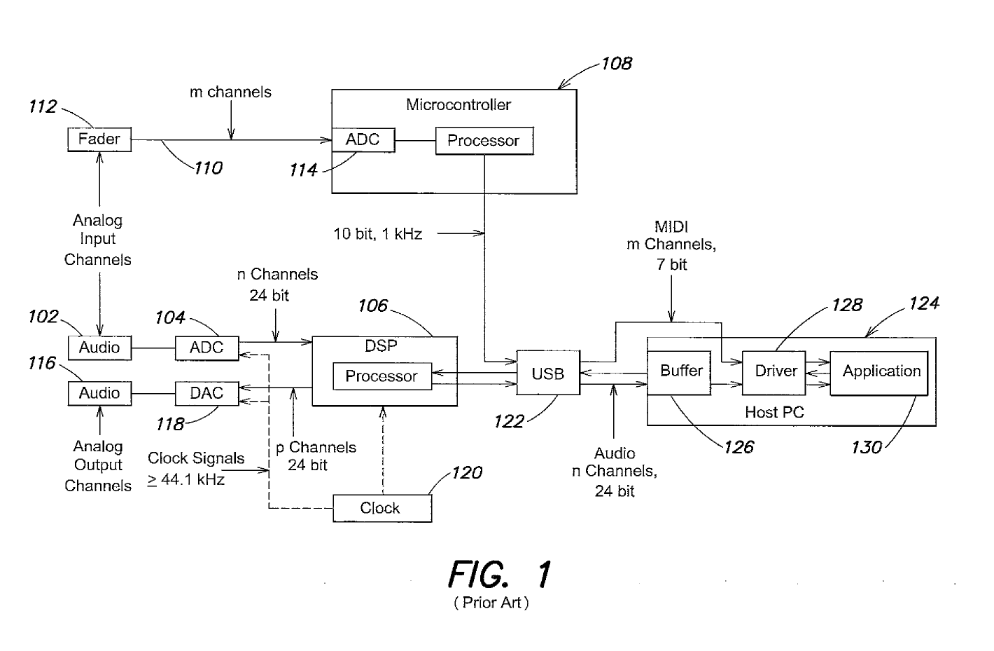

The traditional set-up described above is illustrated in FIG. 1. The analog audio signals 102 are digitized by analog to digital converter (ADC) 104 into 24 bit samples at a sample rate of about 44.1 kHz or higher. The digitized signal is sent to DSP 106 for processing. In applications in which the audio controller is in a stand-alone configuration, the DSP performs tasks such as equalization, gain control, generating audio effects, bus mixing, and signal routing. In host-based configurations, the DSP performs tasks such as equalization, signal routing, and headphone bus mixing. In standalone applications, the digitized fader settings received from microcontroller 108 are applied to the digital audio information by the DSP. The microcontroller receives the analog fader settings information 110 that is output by fader controls 112, and digitizes them with an internal low resolution analog to digital converter 114 into 10-bit samples at a sampling rate of about 1 kHz. The microcontroller further processes the digitized fader information, e.g., performing noise filtering, fader curve processing, and converting 10-bit ADC samples into 7-bit MIDI, before sending it as MIDI data to the DSP, which in turn further processes it, e.g., upsampling, performing integer/float conversion, and applies the fader control to the audio. The resulting audio is routed to audio output channels 116 via digital to analog converter 118. The output channels may be connected to headphones, or amplifier and speaker systems. The sampling rate of analog to digital converter 104 and the digital to analog converter 118 are controlled by clock signals from audio sampling clock 120.

In a typical hosted application, the digitized fader information and audio information are passed separately via USB (or other) port 122 to host computer 124, with the fader information as multiple channels of 7-bit MIDI data, one channel per fader setting, and the audio information as multiple channels of 16-bit or 24-bit audio. At the host, the audio may be input via buffer 126, before being passed via driver 128 to audio application 130. One example of audio application 130 is the Torq® DJ Performance/Production software, available from Avid Technology of Burlington, Mass. The fader information is received by the driver and is also passed to the application, where the fader settings are applied to the audio information. In this traditional arrangement, the application of the low-resolution fader settings to the audio may suffer from the problems highlighted above.

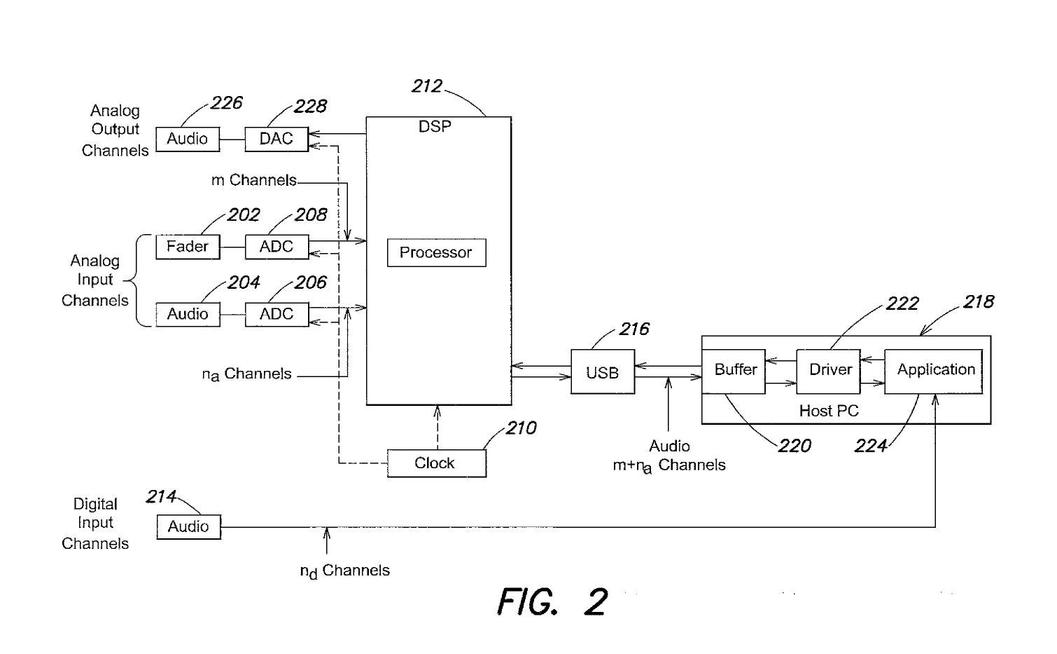

By contrast, in the described embodiment, illustrated in FIG. 2, the analog fader information is digitized at the same sampling rate and phase as the audio, and at a resolution that is the same as the audio resolution, or at least at a resolution of 8 bits or higher. Analog fader control information 202 is digitized at a resolution in the range of 8-16-bit inclusive, 24-bit, or 32-bit resolutions by analog to digital converted 208. If the bit-depth resolution is different from the resolution used for the audio, the DSP converts the fader control information to match the audio resolution before sending it on to the host. The audio data has a bit depth of 16-bit or higher, with 24-bit being a common choice. The input analog audio signals 204 to which the analog controls are to be applied are also digitized. Two ADCs (206, 208) are employed, one to digitize the audio signals and one to digitize the control information. The ADCs are synchronized by signals from audio sampling clock 210, running at 44.1 kHz or higher. In various embodiments, different ADCs are used to digitize different audio channels, or the same ADC is used to digitize both the audio and for the control information. In each case, the one or more ADCs run at the same frequency, and are phase-aligned by the audio sampling clock, which also synchronizes the DSP. Each of the fader control analog signals is converted into a digital channel having the same format as a digital audio channel. Thus, as shown in the figure, m analog fader channels, and nₐ analog audio channels are converted to m+nₐ audio channels, and sent to DSP 212.

In addition, the system may also receive audio channels that are in digital form, such as mp3 or WAV files, from a digital storage device, such as a local hard drive or a server connected via a local area or wide area network. Such digital audio channel are received by host application 224. As indicated in the figure, n_{d} channels are received by the host application, with the total number of audio channels n being the sum of nₐ and n_{d}. DSP 212 performs the functions described above in connection with DSP 106 (FIG. 1), and additionally may perform noise filtering and fader curve processing on the control information, before being output, e.g., via USB port 216, to host 218 as m+nₐ 44.1 kHz (or higher) channels, at 24-bit resolution. The m+nₐ channels are all received by buffer 220, with any potential latency being applied equally to the audio and the fader information, before being passed to driver 222, and audio application 224. The audio application then receives the audio and control information, and applies the fader controls to the desired audio channel(s).

After processing by application 224, the audio is sent back, as indicated by the reverse arrows in FIG. 2, for audio output 226 via digital to analog converter 228.

In general, the system may receive a mixture of audio channels received either from a digital source, such as a hard drive, optical storage, local or networked server, via the Internet, and/or from an analog source, such as a vinyl disc or CD. In one embodiment, the system has four stereo (equivalent to eight mono) audio input channels and the same number of output channels, and a single cross-fader that controls the levels of all the channels. Thus, in this embodiment, n=8 and m=1. Each of the audio inputs may be either digital or analog. The analog channels are digitized using one or more ADCs, as illustrated in FIG. 2; the digital channels are aligned with the corresponding control samples using delay compensation.

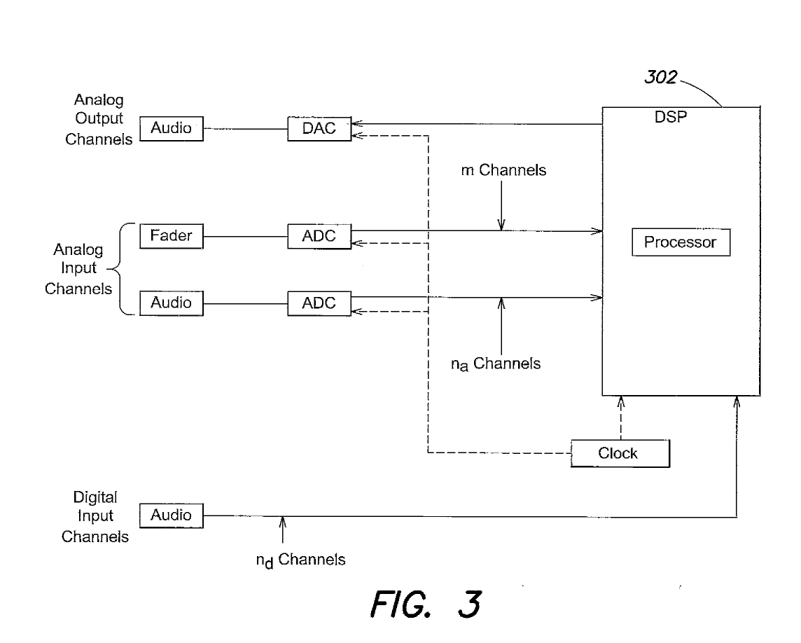

In a standalone embodiment, such as, for example, a standalone digital mixer, the synchronous processing of analog controls is performed within a DSP unit, and no host computer is involved. As illustrated in FIG. 3, DSP unit 302 receives the m channels digitized audio control information, the nₐ channels of digitized audio, as well as the n_{d} channels of digital audio. The DSP synchronously applies the audio controls to the audio channels, and outputs the result, via a digital to analog converter, to the audio output.

In the described system, the analog audio and control information is converted synchronously, thus providing the host system with a sample of control information representing the position of each fader that is matched to each incoming digital audio sample. This permits the computer system to process the digital audio signals using sample-accurate control information captured at bit depths and sample rates that capture all the timing nuances of the performance, thereby matching the accuracy of pure analog mixing systems.

Synchronous control information eliminates the need for upsampling of low resolution control samples, which removes the possibility of zippering effects, and other artifacts. Furthermore, in digital audio systems in which digital audio signals are buffered, the fader position information is captured by the same buffer as the audio information, thus automatically matching the latencies of the two streams. This synchronization of audio samples with their corresponding control information removes the need for mechanisms, such as time-stamping, that correct for synchronization problems.

In addition to synchronously processing the cross-fader, the analog outputs from other audio controls, including vertical faders as well as scratch wheels that simulate vinyl in DJ systems may be synchronously digitized in the manner described herein. An example of a scratch wheel control are the two spinnable platters in the Xponent® system, available from Avid Technology, Inc.

The processing of the described audio control functions may be implemented in hardware, and supplied together with an audio and music playback system, such as a DJ system. Various components of the system described herein may be implemented as a computer program using a general-purpose computer system. Such a computer system typically includes a main unit connected to both an output device that displays information to a user and an input device that receives input from a user. The main unit generally includes a processor connected to a memory system via an interconnection mechanism, and may include one or more digital signal processors (DSPs) to assist with audio signal processing. The input device and output device also are connected to the processor and memory system via the interconnection mechanism.

One or more output devices may be connected to the computer system. Example output devices include, but are not limited to, liquid crystal displays (LCD), plasma displays, cathode ray tubes, video projection systems and other video output devices, printers, devices for communicating over a low or high bandwidth network, including network interface devices, cable modems, and storage devices such as disc or tape. One or more input devices may be connected to the computer system. Example input devices include, but are not limited to, a keyboard, keypad, track ball, mouse, pen and tablet, communication device, and data input devices. The invention is not limited to the particular input or output devices used in combination with the computer system or to those described herein.

The computer system may be a general purpose computer system which is programmable using a computer programming language, a scripting language or even assembly language. The computer system may also be specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services. The computer system may be connected to a local network and/or to a wide area network, such as the Internet. The connected network may transfer to and from the computer system program instructions for execution on the computer, media data, metadata, review and approval information for a media composition, media annotations, and other data. The network may be connected to the various computer and special purpose systems via any standard connection interface, such as USB and FireWire.

A memory system typically includes a computer readable medium. The medium may be volatile or nonvolatile, writeable or nonwriteable, and/or rewriteable or not rewriteable. A memory system typically stores data in binary form. Such data may define an application program to be executed by the microprocessor, or information stored on the disc to be processed by the application program. The invention is not limited to a particular memory system. Time-based media may be stored on and input from magnetic or optical discs, which may include an array of local or network attached discs.

A system such as described herein may be implemented in software or hardware or firmware, or a combination of the three. The various elements of the system, either individually or in combination may be implemented as one or more computer program products in which computer program instructions are stored on a computer readable medium for execution by a computer, or transferred to a computer system via a connected local area or wide are network. Various steps of a process may be performed by a computer executing such computer program instructions. The computer system may be a multiprocessor computer system or may include multiple computers connected over a computer network. The components described herein may be separate modules of a computer program, or may be separate computer programs, which may be operable on separate computers. The data produced by these components may be stored in a memory system or transmitted between computer systems.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A digital audio system comprising:
an audio control device including one or more user-operable analog controls for real time control of a plurality of channels of audio information, wherein each of the one or more user-operable analog controls outputs an analog control signal corresponding to a position of that analog control, and wherein the audio information is digitized at an audio sampling rate;
an analog to digital converter; and
a host computer,
wherein the analog to digital converter receives the one or more analog control signals, samples the analog control signals at the audio sampling rate, and outputs control samples that are synchronous with the audio information, and wherein the host computer receives the control samples and the plurality of channels of audio information, and synchronously processes the audio information in accordance with the control samples.

2. The digital audio system of claim 1, wherein the analog to digital converter samples the analog control signals at a resolution of 24 bits or higher.

3. The digital audio system of claim 1, wherein the analog to digital converter samples the analog control signals at a resolution greater than or equal to 8 bits and less than or equal to 16 bits.

4. The digital audio system of claim 1, wherein the audio information is digitized by the analog to digital converter.

5. The digital audio system of claim 1, further including a second analog to digital converter, and wherein the audio information is digitized by the second analog to digital converter.

6. The digital audio system of claim 1, wherein the audio information is received by the digital audio system in digital form from a digital storage device.

7. The digital audio system of claim 1, wherein the digital audio system is a DJ performance system.

8. The digital audio system of claim 1, wherein the one or more user operable analog controls includes a cross-fader.

9. The digital audio system of claim 1, wherein the audio sampling rate is greater than or equal to 44.1 kHz.

10. An audio processing method comprising:
receiving at an analog to digital converter one or more analog control signals indicative of a position of a corresponding one or more user-operable analog controls for real time control of a plurality of channels of audio information, wherein the audio information is digitized at an audio sampling rate;
using the analog to digital converter, sampling the one or more analog control signals at the audio sampling rate and outputting the sampled control signals synchronously with samples of the audio information;
receiving at a host computer the sampled control signals and the plurality of channels of audio information; and
synchronously processing the plurality of channels of audio information by the host computer in accordance with the control samples.

11. The audio processing method of claim 10, wherein the analog to digital converter samples the analog control signals at a resolution of 24 bits or higher.

12. The audio processing method of claim 10, wherein the analog to digital converter samples the analog control signals at a resolution greater than or equal to 8 bits and less than or equal to 16 bits.

13. The audio processing method of claim 10, wherein the audio information is digitized by the analog to digital converter.

14. The audio processing method of claim 10, further including a second analog to digital converter, and wherein the audio information is digitized by the second analog to digital converter.

15. The audio processing method of claim 10, wherein the audio information is received by the digital audio system in digital form from a digital storage device.

16. The audio processing method of claim 10, wherein the digital audio system is a DJ performance system.

17. The audio processing method of claim 10, wherein the one or more user operable analog controls includes a cross-fader.

18. The audio processing method of claim 10, wherein the audio sampling rate is greater than or equal to 44.1 kHz.

19. A digital audio system comprising:
an audio control device including one or more user-operable analog controls for real time control of a plurality of channels of audio information, wherein each of the one or more user-operable analog controls outputs an analog control signal corresponding to a position of that analog control, and wherein the audio information is digitized at an audio sampling rate;
an analog to digital converter; and
a digital signal processor;
wherein the analog to digital converter receives the one or more analog control signals, samples the analog control signals at the audio sampling rate, and outputs control samples that are synchronous with the audio information, and wherein the digital signal processor receives the control samples and the plurality of channels of audio information, and synchronously processes the audio information in accordance with the control samples.
